(19) United States
(12) Patent Application Publication
(10) Pub. No.: US 2009/0158122 A1
(43) Pub. Date: Jun. 18, 2009

(54) FORWARD ERROR CORRECTION OF AN ERROR ACKNOWLEDGEMENT COMMAND PROTOCOL

(75) Inventor: NICOLAS GAGNON, Braunsehweig (DE)

Correspondence Address: INTEL CORPORATION;c/o CPA Global, P.O. BOX 52050, MINNEAPOLIS, MN, 55402, US

(73) Assignee: INTEL CORPORATION

(21) Appl. No.: 11/954,776

(22) Filed: Dec. 12, 2007

(51) Int. Cl. G06F 11/10

(52) U.S. Cl. 714/763; 714/E11.034

(57) ABSTRACT

Embodiments of the invention are generally directed to systems, methods, and apparatuses for the forward error correction coding of an error acknowledgement command protocol. In some embodiments, a host sends commands to a memory device and monitors an error signal to determine whether the memory device received the commands without error. In some embodiments, if the host detects an error then it provides forward error correction code for an error acknowledge command. Other embodiments are described and claimed.

### TECHNICAL FIELD

Embodiments of the invention generally relate to the field of integrated circuits and, more particularly, to systems, methods and apparatuses for the forward error correction of an error acknowledgement command protocol.

### BACKGROUND

Memory subsystems typically include two or more integrated circuits that transfer information to one another at transfer rates that inevitably increase over time. For example, a host (such as a memory controller) may transfer commands to a memory device over a command interconnect. The reliability of the transfer of commands to a memory device is particularly important because, if an error occurs, then the data stored in memory may be corrupted.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram illustrating selected aspects of a computing system implemented according to an embodiment of the invention.

FIG. 2 is a block diagram illustrating selected aspects of forward error correction logic according to an embodiment of the invention.

FIG. 3 is a block diagram illustrating selected aspects of a high performance computing system implemented according to an embodiment of the invention.

FIG. 4 is a flow diagram illustrating selected aspects of a method for the forward error correction of an error acknowledgement command according to an embodiment of the invention.

### DETAILED DESCRIPTION

Embodiments of the invention are generally directed to systems, methods, and apparatuses for the forward error correction of an error acknowledgement command protocol. In some embodiments, a host sends commands to a memory device and monitors a command ERROR signal to determine whether a transmission error has occurred. If the command ERROR signal is asserted, the host may then implement a forward error correction protocol for the error acknowledgement command. The given protocol is more efficient than conventional approaches because the host can resend the erroneous commands without a delay since it can assume that the error acknowledge command was received error free. In addition, the hardware implementation of the host may be simpler (and/or smaller) since smaller buffers can be used to store commands that may need to be repeated.

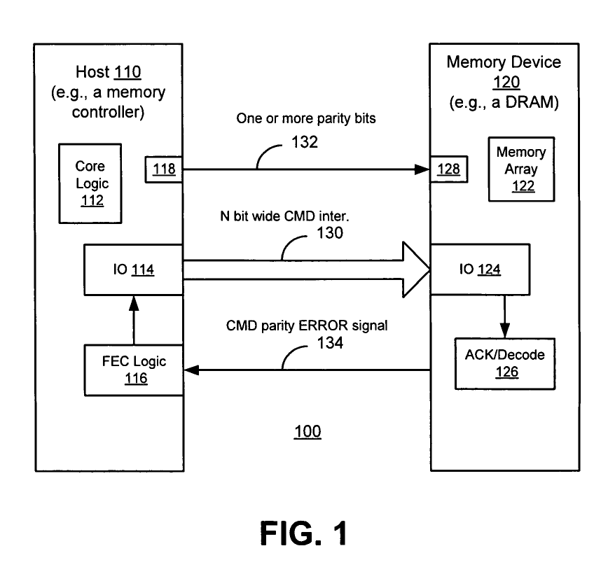

FIG. 1 is a high-level block diagram illustrating selected aspects of a computing system implemented according to an embodiment of the invention. In the illustrated embodiment, system 100 includes host 110 (e.g., a memory controller), memory device 120 (e.g., a dynamic random access memory device or “DRAM”), and N bit wide command (CMD) interconnect 130. For ease of discussion, FIG. 1 only shows a single host and a single memory device. It is to be appreciated, however, that system 100 may have nearly any number of hosts and/or memory devices. For example, system 100 may have a large number of hosts and/or memory devices to support a high performance computing application. In alternative embodiments, system 100 may include more elements, fewer elements, and/or different elements.

CMD interconnect 130 may include a number of signal lines to convey commands, addresses, and the like. In some embodiments, CMD interconnect 130 is unidirectional. CMD interconnect 130 may have any of a number of topologies including, point-to-point, multi-drop, and the like.

Host 110 controls the transfer of data to and from memory device 120. In some embodiments, host 110 is integrated onto the same die as one or more processors. In alternative embodiments, host 110 may be on a die that is packaged with one or more processors. In yet other alternative embodiments, host 110 is part of a chipset for system 100.

Host 110 includes core logic 112, input/output (IO) circuit 114, and forward error correction logic (FEC) 116. Core logic 112 may be nearly any core logic for an integrated circuit including, for example, the core logic to implement one or more memory controller functions. IO circuit 114 may include drivers, buffers, delay locked loops, phase locked loops, and the like to transmit commands to memory device 120 via interconnect 130.

Collectively, parity line 132, CMD interconnect 130, and CMD parity ERROR signal line 134 provide a high-speed digital interface that is (to one degree or another) error prone. CMD interconnect 130 provides a unidirectional N bit (e.g., 1, 2, 3, . . . , N) wide interconnect to transfer commands. Host 110 generates one or more parity bits to cover the commands (e.g., using parity logic 118). The parity bits may be transferred via line 132. As is further discussed below, memory device 120 may assert a CMD parity ERROR signal on line 134 if it detects a parity error.

In some embodiments, memory device 120 provides (at least in part) the main system memory for system 100. In alternative embodiments, memory device 120 provides (at least in part) a memory cache for system 100. Memory device 120 includes memory array 122, IO circuit 124, decode logic 126, and parity logic 128. IO circuit 124 may include latches, buffers, delay locked loops, phase locked loops, and the like to receive one or more signals from host 110. In alternative embodiments, memory device 120 may include more elements, fewer elements, and/or different elements.

Memory device 120 uses parity logic 128 to determine whether there is a parity error for a command that is transferred over interconnect 130. If memory device 120 detects a parity error, then it asserts the CMD parity ERROR signal. Host 110 monitors the interface to detect whether the CMD parity ERROR signal (or, simply, ERROR signal) is asserted.

In some embodiments, if the host detects the assertion of the ERROR signal, then it employs a forward error correction protocol when sending an error acknowledgement command (CMD). For example, in some embodiments, forward error correction logic 116 encodes the error acknowledge CMD with an error correction code. The encoded error acknowledge CMD may be transferred to memory device 120 “in-band” via CMD interconnect 130.

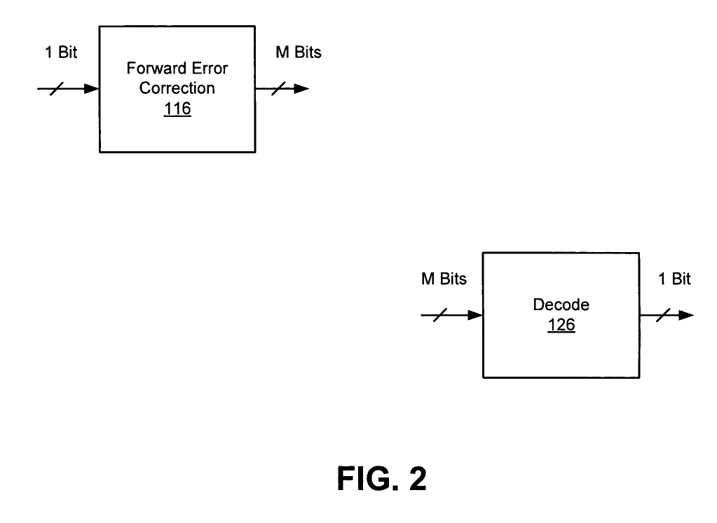

In the illustrated embodiment, memory device 120 includes decode logic 126 to decode the encoded error acknowledge CMD. FEC logic 116 and decode logic 126 are further discussed below with reference to FIG. 2.

FIG. 2 is a block diagram illustrating selected aspects of forward error correction logic according to an embodiment of the invention. Forward error correction logic 116 receives, as an input, an error acknowledge command, and provides, as an output, the error acknowledge command encoded with an error correction code. In some embodiments, the error correction code is a Hamming code. In alternative embodiments, a different error correction code may be used. In the illustrated embodiment, the error acknowledge is a single bit and the encoded acknowledge is M bits (e.g., 2, 3, 4, 5, . . . , M). It is to be appreciated that the number of bits used to encode the error acknowledge CMD will vary depending on the implementation. In some embodiments, logic 116 implements a 3 bit Hamming code. In alternative embodiments, the error acknowledge command may consist of 3 or more bits.

Decode logic 116 receives, as an input, an encoded error acknowledge command, and provides, as an output, the decoded error acknowledge command. In some embodiments, decode logic 116 provides the opposite function of logic 116. For example, if logic 116 provides a 3 bit Hamming code to encode its input, then logic 126 may provide a 3 bit Hamming code to decode its input.

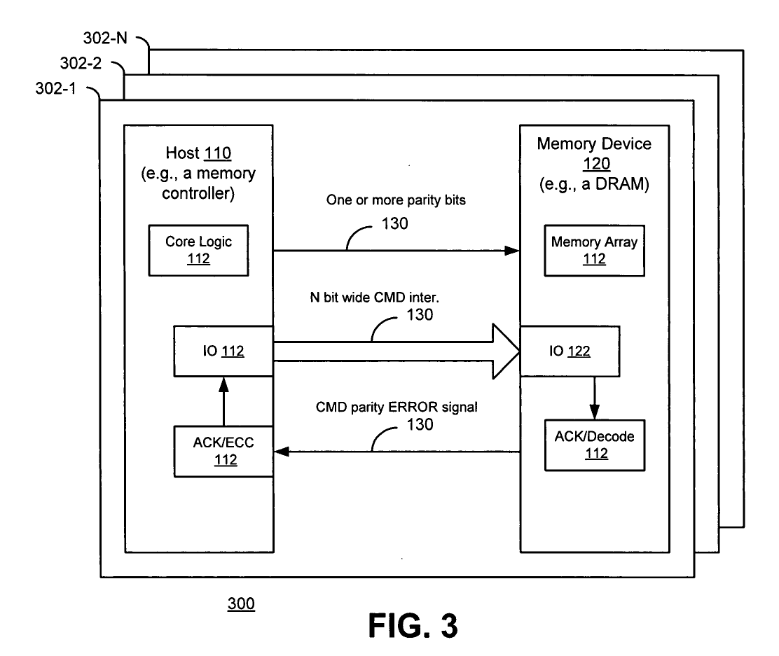

FIG. 3 is a block diagram illustrating selected aspects of a high performance computing system implemented according to an embodiment of the invention. System 300 is a high performance computing platform suitable for performing for example thousands of teraflops (or 1000s of billions of floating point operations per second). System 300 includes a large number of processors 302 working in parallel. In some embodiments, each processor may include a host 110 and one or more DRAMs 120 connected by an error prone interconnect 130. The large number of parallel operations performed by system 300 greatly increases the likelihood that an error will occur on interconnect 130. For example, an error that might only occur after years of operation in a conventional application (e.g., a PC) may occur in hours (or days) in system 300. The enhanced reliability offered by using forward error correction on the error acknowledge command improves the bit error rate (BER) for system 300.

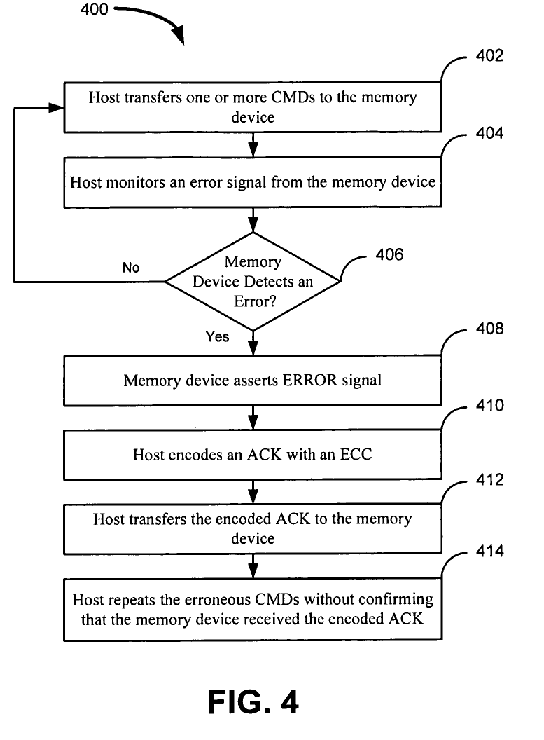

FIG. 4 is a flow diagram illustrating selected aspects of a method for the forward error correction of an error acknowledgement command according to an embodiment of the invention. Referring to process block 402, a host (e.g., host 110, shown in FIG. 1) sends one or more commands to a memory device (e.g., memory device 120, shown in FIG. 1). In some embodiments, the memory device asserts a command parity ERROR signal (or, simply, ERROR signal) if it detects one or more erroneous commands (406, 408).

The host monitors the interface to determine whether the ERROR signal is asserted at 404. Referring to process block 408, the memory device detects an error and asserts the ERROR signal. The host detects the ERROR signal and encodes an ERROR acknowledge command (or, simply, acknowledge) with an error correction code at 410. In some embodiments, the error correction code is a Hamming code.

Referring to process block 412, the host transfers the encoded acknowledge to the memory device. In some embodiments, the acknowledge is transferred over the command interconnect. In alternative embodiments, the acknowledge is transferred via a dedicated pin (and signal line). In yet other alternative embodiments, the acknowledge is multiplexed over another conductor.

Referring to process block 414, the host repeats the erroneous commands without confirming that the memory device received the encoded acknowledge. For example, the host may start repeating the erroneous commands on the next clock cycle after sending the encoded acknowledge because it is reasonably certain that the encoded acknowledge will reach the memory device either without a transmission error or with an error that can be corrected (thanks to the error correction code). In some cases, the performance of the system is improved since the host does not need to wait after sending the encoded acknowledge.

Elements of embodiments of the present invention may also be provided as a machine-readable medium for storing the machine-executable instructions. The machine-readable medium may include, but is not limited to, flash memory, optical disks, compact disks-read only memory (CD-ROM), digital versatile/video disks (DVD) ROM, random access memory (RAM), erasable programmable read-only memory (EPROM), electrically erasable programmable read-only memory (EEPROM), magnetic or optical cards, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the description above, certain terminology is used to describe embodiments of the invention. For example, the term “logic” is representative of hardware, firmware, software (or any combination thereof) to perform one or more functions. For instance, examples of “hardware” include, but are not limited to, an integrated circuit, a finite state machine, or even combinatorial logic. The integrated circuit may take the form of a processor such as a microprocessor, an application specific integrated circuit, a digital signal processor, a micro-controller, or the like.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of embodiments of the invention, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the claims following the detailed description are hereby expressly incorporated into this detailed description.

What is claimed is:

1. An integrated circuit comprising:
core logic;
an input/output (IO) circuit coupled to the core logic, the IO circuit to provide commands to a memory device over an N bit wide command interconnect;
parity logic to provide one or more parity bits to cover the commands provided on the N bit wide command interconnect, wherein the memory device is to provide a command parity ERROR signal if it detects a parity error; and
logic to encode an acknowledge with an error correction code and provide the acknowledge to the memory device, responsive to receiving the command parity ERROR signal, wherein the acknowledge is one or more bits to acknowledge the command parity ERROR signal.

2. The integrated circuit of claim 1, wherein the acknowledge is provided to the memory device via the N bit wide command interconnect.

3. The integrated circuit of claim 1, wherein the core logic resends one or more commands to the memory device without determining whether the memory device received the acknowledge.

4. The integrated circuit of claim 3, wherein the core logic comprises a memory controller.

5. The integrated circuit of claim 4, wherein the core logic further comprises a processor.

6. The integrated circuit of claim 1, wherein the error correction code comprises a Hamming code.

7. The integrated circuit of claim 1, wherein the memory device is a dynamic random access memory device (DRAM).

8. A method comprising:
sending one or more commands from a host to a memory device via a command interconnect, wherein at least some of the one or more commands are covered by one or more parity bits;
monitoring an input for a command parity ERROR signal from the memory device;
receiving the command parity ERROR signal from the memory device, if the memory device detects a parity error;
encoding an acknowledge with an error correction code, wherein the acknowledge is one or more bits to acknowledge the command parity ERROR signal; and
sending the acknowledge to the memory device.

9. The method of claim 8, wherein encoding the acknowledge with the error correction code comprises:
encoding the acknowledge with a Hamming code.

10. The method of claim 8, wherein sending the acknowledge to the memory device comprises:
sending the acknowledge to the memory device via the command interconnect.

11. The method of claim 8, further comprising:
resending one or more commands to the memory device without determining whether the memory device received the acknowledge.

12. The method of claim 8, wherein the host comprises a memory controller.

13. The method of claim 8, wherein the memory device comprises a dynamic random access memory device (DRAM).

14. A system comprising:
a first integrated circuit to receive one or more commands from a second integrated circuit; and
the second integrated circuit coupled with the first integrated circuit via an N bit wide command interconnect, the second integrated circuit including,
core logic;
an input/output (IO) circuit coupled to the core logic, the IO circuit to provide the one or more commands to the first integrated circuit over the N bit wide command interconnect;
parity logic to provide one or more parity bits to cover the commands provided on the N bit wide command interconnect, wherein the first integrated circuit is to provide a command parity ERROR signal if it detects a parity error; and
logic to encode an acknowledge with an error correction code and provide the acknowledge to the memory device, responsive to receiving the command parity ERROR signal, wherein the acknowledge is one or more bits to acknowledge the command parity ERROR signal.

15. The system of claim 14, wherein the first integrated circuit is a memory device.

16. The system of claim 15, wherein the acknowledge is provided to the memory device via the N bit wide command interconnect.

17. The system of claim 15, wherein the core logic resends one or more commands to the memory device without determining whether the memory device received the acknowledge error free.

18. The system of claim 14, wherein the core logic comprises a memory controller.

19. The system of claim 14, wherein the memory device comprises a dynamic random access memory device (DRAM).

20. The system of claim 19, wherein the DRAM includes logic to decode the acknowledge.
